(19) United States
(12) Patent Application Publication
(10) Pub. No.: US 2022/0403957 A1
(43) Pub. Date: Dec. 22, 2022

(54) AN UNBONDED FLEXIBLE PIPE

(71) Applicant: National Oilwell Varco Denmark I/S, Brøndby (DK)

(72) Inventors: Inger-Margrete Procida, Brøndby (DK); Adam Rubin, Brøndby (DK); Anders Lyckegaard, Brøndby (DK)

(21) Appl. No.: 17/756,086

(22) PCT Filed: Nov. 16, 2020
(86) PCT No.: PCT/EP2020/082254

§ 371 Date: May 17, 2022

(30) Foreign Application Priority Data
Nov. 25, 2019 (DK) PA 2019 01389

(51) Int. Cl. F16L 11/08

(52) U.S. Cl. CPC F16L 11/083

(57) ABSTRACT

A subsea installation including an unbonded flexile pipe for subsea transportation of a H₂S and/or CO₂ containing fluid. The unbonded flexible pipe includes from inside and out, a pressure sheath defining a bore for transportation of the fluid, a tensile armor and a liquid impervious outer sheath, wherein the tensile armor is of corrosion resistant material(s) and the tensile armor includes at least two cross wound layers of elongate armor elements, which are wound with a long pith and wherein the pipe further includes an anti-bird cage layer including at least one elongate element wound with a short pitch onto at least one of the tensile armor layers, and wherein the at least one elongate element includes or consist of steel, titanium and/or fibers of carbon, basalt, polyethylene, PVDF (polyvinylidene fluoride or polyvinylidene difluoride) PEEK (polyether ether ketone) PVC (polyvinyl chloride), LCP (liquid crystalline polymer) or any combinations thereof.

### TECHNICAL FIELD

The present invention relates to an unbonded flexible pipe suitable for subsea transportation of a carbon dioxide and/or hydrogen sulfide containing fluid, such as for transport of petrochemical fluids e.g. oil or gas or in a sub-sea environment.

Flexible pipes for offshore applications are generally known from the standard “Recommended Practice for Flexible Pipe”, ANSI/API 17 B, fifth Edition, May 2014 (hereafter API17B), and the standard “Specification for Unbonded Flexible Pipe”, ANSI/API 17J, Fourth edition, May 2014 (hereafter API17J).

An unbonded pipe generally is a pipe comprising separate layers, including armor layer(s) and polymeric layer(s), which allow relative movement between layers.

Such an unbonded flexible pipe generally comprise separate unbonded polymeric layers, such as extruded polymeric layers and armor layers, which allows relative movement between layers. The armor layers are typically helical wound armor layers, such as metallic helically wound armor layers.

A typical unbonded flexible pipe comprises from the inside and outwards an optional inner armor layer known as the carcass, an internal pressure sheath comprising an extruded polymer layer surrounded by one or more armor layers and an outer sheath (also referred to as external protective polymer sheath), such as an extruded polymer layer. The unbonded pipe may comprise additional layers, such as intermediate polymer layers, insulation layers, additional armor layers, and wound tape layers.

The carcass is not fluid tight and thus, the internal pressure sheath, usually an extruded polymer layer, forms a bore in which the fluid to be transported is conveyed and thereby ensures internal fluid integrity and stability. In some unbonded flexible pipes, the carcass may be omitted.

The armor layers surrounding the internal pressure sheath may for example comprise one or more pressure armor layers comprising one or more armor profiles or strips, which are wound around the internal pressure sheath at a large angle (short pitch), e.g. larger than 80°, relative to the center axis of the pipe. This or these pressure armor layers primarily compensate for radial forces in the pipe. The armor layers surrounding the internal pressure sheath may also usually comprise one or more tensile armor layers which are wound at a relatively small angle (large pitch), such as between 10° and 50°, relative to the center axis of the pipe. This or these tensile armor layers primarily compensate for axial forces in the pipe. The armor layers surrounding the internal pressure sheath are typically made of carbon steel due to the high strength required for the pipe.

Where the pipes are for use under water and especially deep water the pipes may be subjected to high axial forces, which may result in radial buckling which completely damage the pipe. A known solution that makes it possible to reduce this risk of radial buckling in “bird cage” form consists in winding a helix with short pitch, around the layers of tensile armor wires, based on aramid fiber-reinforced tapes. These tapes exhibit a high mechanical tensile strength on their longitudinal axis.

In general, flexible pipes are expected to have a lifetime of about 20 years in operation.

Unbonded flexible pipes are e.g. used for the transport of fluids, such as oil and gas between offshore installations, e.g. at large or intermediate sea depths. The fluid may comprise a hydrocarbon fluid, such as gas, oil, water, CO₂, H₂S or a mixture comprising one or more of these depending upon the nature of the hydrocarbon reservoir. The fluid may also be an injection fluid such as water, CO₂ or methanol.

Thus, the internal pressure sheath forms the bore in which the fluid to be transported is flowing. The internal pressure sheath and a surrounding fluid impermeable sheath, the outer sheath or an intermediate sheath, form an annular volume, known as the annulus, which comprises one or more layers of armoring layers and an annular void. Where the unbonded flexible pipe comprises an intermediate layer the pipe may comprise two annuluses.

Although the sheaths forming the annular volume in principle are impermeable, gases may migrate through the sheaths into the annular volume over time. From the bore of the pipe, gasses, such as CO₂ and H₂S, may permeate through the sheath into the annular volume and cause corrosion of the armoring layers in the annular volume, which are typically made from carbon steel. In particular, CO₂ and H₂S become very corrosive if the annulus has a high moisture content. Though the intension may be to keep the annulus space dry, moisture or water may come from different sources either by permeation of water from the bore stream or from the external water e.g. by breach of the outer sheath or through low performing sealings. In practice, it is not possibly to keep the annulus entirely dry. It should be understood that when referring to corrosion or pH this will always be in the moisture or wetted condition due to the physical requirement for presence of water for these phenomena.

In order to reduce the corrosive effect it is standard to vent out gasses via one or both end fittings of the pipe. However, where the fluid transported in the pipe has a high content of corrosive substances, in particular CO₂ and H₂S it may not be sufficient to vent the annulus.

In GB2481175 is has been suggested to provide the tensile armor wires of stainless steel and to ensure a high strength by hammer hardening the steel. In GB2572120, it has been suggested to provide a metal barrier between the armor and the pressure sheath. Several other attempts have been made to prevent the gasses to migrate into the annulus.

However, where the content of CO₂ and/or H₂S is very high, none of the above solutions have been successful for the flexible pipe during its service life.

Usually the required lifetime of an unbonded flexible pipe is 20 years.

### DISCLOSURE OF INVENTION

An objective of the invention is to provide a subsea installation for transportation of H₂S and/or CO₂ containing fluid and comprising an unbonded flexible pipe with a long lifetime.

In an embodiment, it is an objective of the invention to provide a subsea installation comprising an unbonded flexile pipe which is particularly suitable for subsea transportation of fluid with high content of carbon dioxide and which pipe has a high chemical resistance.

These and other objects have been solved by the invention as defined in the claims and as described herein below.

It has been found that the invention or embodiments thereof have a number of additional advantages, which will be clear to the skilled person from the following description.

The subsea installation of the invention comprises an unbonded flexible pipe for subsea transportation of a H₂S and/or CO₂ containing fluid, wherein the unbonded flexible pipe is composed to be very suitable for transporting fluids with high content of H₂S and/or CO₂.

The unbonded flexible pipe comprises from inside and out, a pressure sheath defining a bore for transportation of the fluid, a tensile armor and a liquid impervious outer sheath, wherein the tensile armor is of corrosion resistant material(s) and the tensile armor comprises at least two cross wound layers of elongate armor elements, which are wound with a long pith and wherein the pipe further comprises an anti-bird cage layer comprising at least one elongate element wound with a short pitch onto at least one of the tensile armor layers, and wherein said at least one elongate element comprises or consist of steel, titanium and/or fibers of carbon, basalt, polyethylene, PVDF (polyvinylidene fluoride or polyvinylidene difluoride) PEEK (polyether ether ketone) PVC (polyvinyl chloride), LCP (liquid crystalline polymer) or any combinations thereof.

In an embodiment, an anti-bird cage layer comprising at least one elongate element is wound with a short pitch onto the outermost of the tensile armor layers and at least one elongate element is wound with a short pitch between the tensile armor layers.

In the prior art attempt for increasing the lifetime of the unbonded flexible pipe for use in transporting fluids with high content of H₂S and/or CO₂, the focus has exclusively been directed to protecting the armors against corrosion.

Hence, it has previously been attempted to use stainless steel or composite material for the pressure armor and tensile armor. However, it has been found that this solution does not work where the armor layers are located in an annulus and where the H₂S and/or CO₂ content becomes rather high, without simultaneously reducing the lifetime of the unbonded flexible pipe to an unacceptable level.

After many long time experiments and analyses the inventor have found that, the loss of lifetime mainly is caused by a loss of the anti-bird cage protection. The use of composite material for the armor layers may include that the armor layers was not located in an annulus. Generally, where the armor has been located in the annulus, the armor layers have been made from carbon steel. The inventors have found that the problem of loss of anti-bird cage protection actually is caused by omitting carbon steel from the annulus. When the pipe is installed and transports the acidic fluid, the CO₂ and H₂S permeates into the annulus and create an acidic environment in the annulus. In conventional designs with carbon steel based armor materials, this effect is counteracted by the corrosion of carbon steel in the annulus and the acidification is limited. The absence of carbon steel in the annulus removes the limiting effect on the acidification. Thus, a more acidic environment in the annulus will develop. It has been found that by replacing the carbon steel in the annulus with corrosion resistant material, the pH value in the annulus drastically drops e.g. to pH 3 or less. Due to the contact pressure between the anti-bird cage aramid tapes and the stainless steel wires at this highly acidic environment, the aramid starts a very fast hydrolysis process, which is particularly intensive where the contact pressure is high. This may over time lead to local break of the aramid tapes and hence, loss of the anti-bird cage protection. This problem is solved by the present invention.

The subsea installation of the present invention ensures an increased durability of the anti-bird cage layer and thereby of the entire unbonded flexible pipe and the subsea installation especially where the unbonded flexile pipe is arranged for subsea transportation of a sour fluid. In previous installation where the anti-bird cage layer was made from materials comprising less acidic resistive materials, such as polyamides, the anti-bird cage layer would have a reduced durability where the flexile pipe is arranged for subsea transportation of a sour fluid.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

Reference made to “some embodiments” or “an embodiment” means that a particular feature, structure, or characteristic described in connection with such embodiment(s) is included in at least one embodiment of the subject matter disclosed. Thus, the appearance of the phrases “in some embodiments” or “in an embodiment” in various places throughout the specification is not necessarily referring to the same embodiment(s). Further, the skilled person will understand that particular features, structures, or characteristics may be combined in any suitable manner within the scope of the invention as defined by the claims.

The term “substantially” should herein be taken to mean that ordinary product variances and tolerances are comprised.

Throughout the description or claims, the singular encompasses the plural unless otherwise specified or required by the context.

All features of the invention and embodiments of the invention as described herein, including ranges and preferred ranges, may be combined in various ways within the scope of the invention, unless there are specific reasons not to combine such features.

The term “cut fibers”, means herein fibers of non-continuous length, e.g. in the form of chopped fibers or melt blown fibers. The cut fibers are usually relatively short fibers e.g. less than about 5 cm, such as from about 1 mm to about 3 cm in length. The cut fibers may have equal or different lengths.

Filaments are continuously single fiber (also called monofilament).

The phrase “continuous” as used herein in connection with fibers, filaments, strands, or rovings, means that the fibers, filaments, strands, yarns, or rovings means that they generally have a significant length but should not be understood to mean that the length is perpetual or infinite. Continuous fibers, such as continuous filaments, strands, yarns, or rovings preferably have length of at least about 10 m, preferably at least about 100 m, more preferably at least about 1000 m.

The term “strand” is used to designate an untwisted bundle of filaments.

The term “yarn” is used to designate a twisted bundle of filaments and/or cut fibers. Yarn includes threads and ropes. The yarn may be a primary yarn made directly from filaments and/or cut fibers or a secondary yarn made from yarns and/or cords. Secondary yarns are also referred to as cords.

The term “roving” is used to designate an untwisted bundle of strands or yarns. A roving includes a two or more strands, each of more than two filaments.

The term “cross-wound layers” means that the layers comprises wound elongate elements that are wound in opposite direction relatively to the longitudinal axis of the pipe where the angle to the longitudinal axis can be equal or different from each other.

Other term definitions may be found in API17B and API17J.

In an embodiment, the unbonded flexible pipe comprises a pressure sheath defining a bore for transportation of the fluid, a pressure armor surrounding the pressure sheath, a tensile armor surrounding the pressure armor and a liquid impervious outer sheath, wherein the pressure armor and the tensile armor are of corrosion resistant material(s). The tensile armor comprises at least two cross wound layers of elongate armor elements, which are wound with a long pitch and wherein the pipe further comprises an anti-bird cage layer comprising at least one elongate element wound with a short pitch onto the outermost of the tensile armor layers, and wherein the at least one elongate element comprises or consist of steel, titanium and/or fibers of carbon, basalt, polyethylene, PVDF (polyvinylidene fluoride or polyvinylidene difluoride) PEEK (polyether ether ketone) PVC (polyvinyl chloride), LCP (liquid crystalline polymer) or any combinations thereof.

The pressure sheath and the outer sheath is advantageously arranged to form an annulus and the armor layers are located in the annulus. In an embodiment, the unbonded flexible pipe comprises a liquid impermeable intermediate sheath between the pressure sheath and the outer sheath.

The anti-bird cage layer may be wound onto two or more of the tensile armor layers or it may be wound onto a single one of the tensile armor layers.

In an embodiment, at least one of the at least one elongate element of the anti-bird cage layer, is wound with a short pitch onto an outermost of the tensile armor layers. In an embodiment, at least one of the at least one elongate element of the anti-bird cage layer, is wound with a short pitch onto an innermost of the tensile armor layers.

The installation is suitable for transportation of a highly acidic fluid. Beneficially, the installation is arranged for transportation of a highly acidic fluid, preferably for a long period of time, such as for at least 2 years, such as at least 5 years such as for 10 to 20 years.

The unbonded flexile pipe may be arranged for subsea transportation of an acidic crude oil and/or gas at an increased temperature inside the bore of the pipe. It has been found that even where the temperature of the fluid within the bore reaches a very high temperature, the unbonded flexible pipe maintain a long lifetime with low risk of a loss of the anti-bird cage protection.

In an embodiment, the increase temperature inside the bore is above 30° C., such as above 40° C. or even reaching about 90° C., such as at least about 100° C. inside the bore of the pipe.

When the pipe is installed and transports fluid containing CO₂ and/or H₂S these species permeates into the annulus and together with waters creates an acidic environment in the annulus. In conventional designs with carbon steel based armor materials, this effect is counteracted by the chemical corrosion reactions of carbon steel in the annulus and the acidification is limited. The absence of carbon steel in the annulus removes the limiting effect on the acidification, and pH is determined only by the acidic reactions of CO₂ and/or H₂S. This results in a lower pH in the annulus with no carbon steel compared to an annulus with carbon steel. It has been found that by replacing the carbon steel in the annulus with corrosion resistant material, the pH value in the annulus drastically drops following for instance the CO₂ content e.g. to around pH 3.5 for 10 bar CO₂ in annulus and below pH 3.0 at 50 bar CO₂ in annulus.

In an embodiment, the unbonded flexile pipe is arranged for transporting production fluid at least a part of a way from a production site to a sea surface installation. The unbonded flexible pipe may for example be a flow line and/or a riser pipe. The installation is particularly beneficial for transportation of petrochemical production fluids e.g. for transporting the fluid from a well to a platform or a vessel located at the sea surface. In an embodiment, the installation comprises one of more additional pipes connected to the unbonded flexible pipe.

In an embodiment, the production site, such as the well is located at least about 100 m below sea surface, such as at least about 1 Km below sea surface. Usually the H₂S and/or CO₂ content of the oil/gas of a well increases the deeper the well is located and also the buckling forces on the pipe increases with water depth.

In an embodiment, the fluid is a CO₂ containing injection fluid and the unbonded flexile pipe is arranged for transporting the injection fluid at least a part of a way from a sea surface installation to a seabed installation. The injection of CO₂ may be provided in order to store CO₂ underground and/or in connection with enhanced oil recovery (EOR) where the CO₂ facilitates a higher flow rate of e.g. crude oil from the reservoir.

In an embodiment, at least a length section of the unbonded flexible pipe is located at least about 100 m below sea surface, such as at least about 1 Km below sea surface.

The elongate element of the anti-bird cage layer is wound with an angle of at least about 65° to the center axis of the unbonded flexible pipe, such as an angle of least about 75°, such as an angle of least about 80° to the center axis of the unbonded flexible pipe. Thereby an optimal a desired anti-bird cage protection may be obtained and maintained over time.

In an embodiment, the elongate element of the anti-bird cage layer comprises fibers of stainless steel, titanium, carbon, basalt, ultra-high-molecular polyethylene (UHMWPE), LCP (liquid crystalline polymer) or any combinations thereof. These materials ensure that the anti-bird cage layer has a very long lifetime even when the pH value in the annulus is very low and where a high amount of H₂S and/or CO₂ have migrated through the pressure sheath and into the annulus.

Fiber containing and/or fiber based elongate elements are beneficial due to their ease of winding in production. In addition the containing and/or fiber based elongate elements has relatively low or none bend stiffening effect of the unbonded flexible pipe.

Preferably, the fibers are carbon fibers, stainless steel fibers, Ultra-high-molecular-weight polyethylene (UHMWPE, UHMW) fibers, LCP (liquid crystalline polymer) or any combinations comprising one or more of these.

Advantageously the fibers comprise bundles of twisted or untwisted continuous fibers, preferably each bundle of continuous fibers comprises at least 50 filaments, preferably each bundle of continuous fibers comprises from 100 to 50000 filaments, such as from 500 to 1000 filaments. It has been found that anti-bird cage elongate elements where the fibers are in the form of bundles of continuous fibers the strength and durability are very high and thereby risk of loss of the anti-bird cage protection is even further reduced.

In an embodiment, the fiber bundles are twisted to form threads. The threads may for example be as thick as up to 5 mm in diameter. Generally, it is desired that the threads have a diameter from 0.1 mm to 3 mm, such as from 0.5 mm to 2 mm.

In an embodiment, the fibers independently of each other have thicknesses from 5 μm and 250 μm, such as from 10 μm to 200 μm, such as from 20 μm to 100 μm. Hence, the fibers may have equal or different thickness. Preferably, at least 80% of the fiber mass fibers have thicknesses within ±10 μm from the average fiber thickness, such as thicknesses within ±2 μm from the average fiber thickness.

To ensure a very high strength and wear resistance of the elongate elements of the anti-bird cage layer, the fibers are advantageously embedded in a polymer material. The polymer material should be selected to be resistant to the acid environment in the annulus. Preferred polymer materials include polyethylene, PVDF, PEEK, PVC or any combination thereof. Preferred combinations of fibers and embedding polymer material includes steel fibers embedded in PVDF, steel fibers embedded in UHMWPE, carbon fibers embedded in PE, UHMWPE, PVDF, LCP or PEEK and UHMWPE fibers embedded in PVDF.

UHMWPE has been found to be very advantageous in the elongate element. UHMWPE material has a desirable low friction and a high abrasion resistance.

In an embodiment, the elongate element comprises fiber bundles of UHMWPE.

The fibers may for example be dispersed in the embedding polymer material and the elongate element may be in the form of flat tapes. The tapes may e.g. have a thickness of from 0.2 mm to 3 mm, such as from about 0.5 to 1 mm. Such tapes have a high strength and are very flexible and therefore simple to be wound. The tapes may be wound with or without overlapping edges.

In an embodiment, the elongate element(s) of the anti-bird cage layer comprises a row of parallel arranged filament bundles embedded in the polymer material(s). Preferably, the fiber bundles are of carbon fibers and/or UHMWPE.

In an embodiment, the elongate element(s) of the anti-bird cage layer comprises embedded cut fibers, preferably dispersed in in at least 50% of the thickness of the elongate element(s).

In an embodiment, the anti-bird cage layer provides a thermal insulation. Advantageously the fibers are polymer fibers.

The thickness of the anti-bird cage layer is advantageously form about 0.1 mm to about 2 cm, such as from about 0.5 mm to 1 cm or 1 mm to 1 cm. Thicker tapes and tape layers is specifically preferred where the anti-bird cage elongate element also has function as thermal insulation.

The unbonded flexible pipe may comprise two or more anti-bird cage layers. Layers may be bonded together partly or fully as part of the tape laying process. The two or more anti-bird cage layers may be equal or different.

In an aspect of the invention, the anti-bird cage layer comprises a steel strip or a titanium strip, preferably comprising an organic and/or an inorganic coating. The organic coating may e.g. a coating of one or more of the polymers mentioned above. The inorganic coating may for example be a carbon coating and/or an aluminum coating. The steel strip may advantageously be a stainless steel strip or a strip comprising a coating of stainless steel.

In an embodiment, the anti-bird cage layer may conveniently be located in the annulus. Thus due to the selection of the material providing the elongate element constituting the anti-bird cage layer, the anti-bird cage layer will be capable of sustaining its strength in the very acidic environment in the annulus.

In an embodiment, the anti-bird cage layer is located in physical contact with at least one of the armor layers such as an outermost of the tensile armor layers. The anti-bird cage layer may advantageously be applied directly onto and in contact with an outermost of the tensile armor layers.

In an embodiment, the unbonded flexible pipe further comprises a stabilization layer located outside the tensile armor layers and wherein the anti-bird cage layer is located onto and in contact with the stabilization layer.

The stabilization layer serve a double purpose. First, the stabilization layer has the function of providing a support during winding of the elongate element(s) to ensure that the elongate element is wound with the desired winding angle according to selected specifications and to ensure that the elongate element(s) is not slipping over the smooth surface of the tensile armor layer. Thereby a more accurate winding of the elongate element(s) of the anti-bird cage layer may be provided, Second, the stabilization layer has the function of providing a good grip of the windings of the anti-bird cage layer during the operation of the installation, as well as during deployment of the unbonded flexible pipe where the unbonded flexible pipe may be subjected to large and rapid bends as well as large inertial force, to thereby ensure that the windings are not relocating along the length of the pipe.

The stabilization layer thereby ensure that the anti-bird cage layer remain very stable. The stabilization layer may advantageously be a wound layer. Such a wound layer is generally permeable for fluids. However, due to the selection of the material providing the elongate element constituting the anti-bird cage layer, the anti-bird cage layer will be capable of sustaining its strength in the very acidic environment in the annulus.

Advantageously, the stabilization layer is provided from helically wound polymeric strips The helically wound polymeric strips may advantageously be of polyethylene, PVDF, PEEK, PVC or any combination thereof optionally comprising embedded fibers. Where the helically wound polymeric strips of the stabilization layer comprises fibers, these fibers may advantageously be cut fibers and/or continuous fibers located both lengthwise and crosswise the polymeric strip, e.g. in a braided structure.

The helically wound polymeric strips are advantageously wound with a longer pitch than the pitch of the at least one elongate element of the anti-bird cage layer. Thereby an even more effective stabilization of the elongate element windings may be obtained. Advantageously, the helically wound polymeric strips are wound with an angle to the center axis of the unbonded flexible pipe, which is at least about 10° less than the winding angle of the elongate element(s) of the anti-bird cage layer, such as at least about 15° less than the winding angle of the elongate element(s) of the anti-bird cage layer, such as at least about 20° less than the winding angle of the elongate element(s) of the anti-bird cage layer, such as at least about 30° less than the winding angle of the elongate element(s) of the anti-bird cage layer.

Thus, in an embodiment the elongate element(s) of the anti-bird cage layer is wound with an angle to the center axis of the unbonded flexible pipe, which is about 70° to about 80° and the helically wound polymeric strips are advantageously wound with an angle to the center axis of the unbonded flexible pipe which is less than 60°, such as about 35° to about 55°.

In an embodiment, the outer sheath is applied directly onto the anti-bird cage layer or onto an insulating layer.

In a further embodiment, the anti-bird cage layer is located outside the annulus. The anti-bird cage layer may be located onto and in contact with the outer sheath. Thereby even if the acidic gasses penetrated through the outer sheath, the selection of the material providing the elongate element constituting the anti-bird cage layer ensure high durability of the anti-bird cage layer. Advantageously a further protection layer is located outside the anti-bird cage layer, such as a liquid permeable layer providing mechanical protection of the anti-bird cage layer.

The corrosion resistant material of the tensile armor and the pressure armor may advantageously comprise stainless steel, titanium, composite material or any combinations thereof.

The corrosion resistant material of the tensile armor may be equal to or different from the corrosion resistant material of the pressure armor.

In an embodiment, the corrosion resistant material is a composite material comprising a fiber reinforced polymer material. The fibers are preferably fibers of stainless steel, titanium, carbon, basalt, polyethylene, or any combinations thereof, more preferably the fibers are carbon fibers.

The fibers preferably, comprise continuous fibers. The fibers may be in bundles or they may be dispersed in the polymer material. In an embodiment, the fibers comprise bundles of twisted or untwisted continuous fibers, preferably each bundle of continuous fibers comprises at least 50 filaments, preferably each bundle of continuous fibers comprises from 100 to 50000 filaments, such as from 500 to 1000 filaments.

In an embodiment, the fibers are embedded in the polymer material by a pultrusion process for example using a process as described in WO2012/076017, U.S. Pat. No. 6,872,343 and/or U.S. Pat. No. 6,106,944. In an embodiment, the fibers are embedded in the polymer using a process as described in WO02/095281

Advantageously, the polymer material is a thermoset polymer material or a thermoplastic polymer material, preferably epoxy, vinylester, polyethylene, polypropylene, PVDF or PEEK.

The pressure armor may comprise one or more layers of helically wound and preferably interlocked elongate armor elements, wound with an angle of at least about 65° to the center axis of the unbonded flexible pipe, such as an angle of least about 75°, such as an angle of least about 80° to the center axis of the unbonded flexible pipe.

The elongate armor elements of the tensile armor are wound with an angle of between 30° and 55° to the center axis of the unbonded flexible pipe, such as an angle of between 35° and 45° to the center axis of the unbonded flexible pipe. The tensile armor may conveniently comprise two layers of elongate armor elements wherein the layers are cross wound.

In an embodiment, the elongate armor elements of the tensile armor and/or of the pressure armor are of carbon fiber reinforced polyethylene (PE), carbon fiber reinforced PVDF, carbon fiber reinforced PEEK or carbon fiber reinforced polypropylene (PP).

In a preferred embodiment, the elongate armor elements of the tensile armor and/or of the pressure armor are of stainless steel.

The pressure sheath is advantageously of HDPE, PVDF or XLPE (cross-linked polyethylene), which also ensures a long durability. These materials have been found to be very resistant to the acidic environment in the annulus. The outer sheath is advantageously of polyethylene or TPV (thermoplastic vulcanisate) which are also resistant to the acidic annulus.

Advantageously the unbonded flexible pipe additionally comprises a carcass. In an embodiment, the unbonded flexible pipe does not comprise a carcass.

The invention also comprises an unbonded pipe as described herein.

All features of the inventions including ranges and preferred ranges can be combined in various ways within the scope of the invention, unless there are specific reasons not to combine such features.

### BRIEF DESCRIPTION OF THE EXAMPLES AND DRAWING

The invention is being illustrated further below in connection with illustrative embodiments and with reference to the figures. The figures are schematic and may not be drawn to scale.

FIG. 1 is a schematic, perspective view of an unbonded flexible pipe forming part of an embodiment of the installation.

FIG. 2 is a schematic, side view and partly cross-sectional view of an unbonded flexible pipe forming part of an embodiment of the installation.

FIG. 3 illustrates an installation according to an embodiment of the invention FIGS. 4a-4e are cross-sectional views of an embodiments of anti-bird cage layer elongate elements.

FIG. 5 is a schematic, side view of an unbonded flexible pipe forming part of an embodiment of the installation.

FIG. 6 is a schematic, side view of a further unbonded flexible pipe forming part of an embodiment of the installation.

FIG. 7 is a schematic, side view of a further unbonded flexible pipe forming part of an embodiment of the installation.

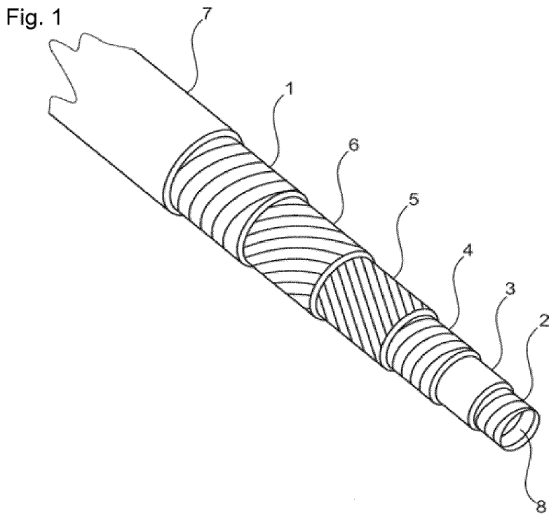

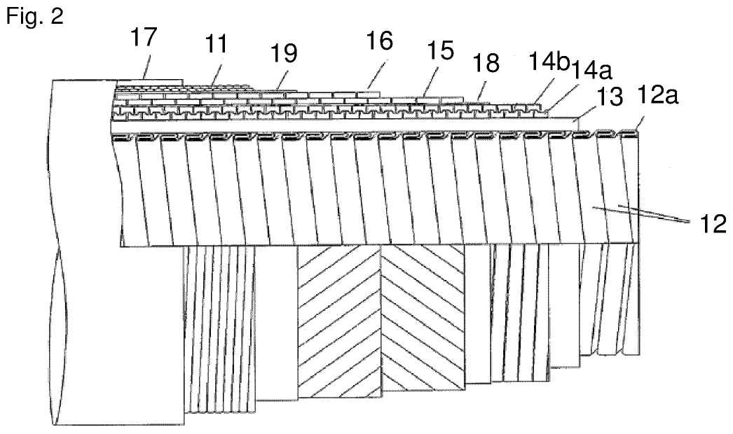

The unbonded flexible pipe shown in FIG. 1 comprises from inside and out a carcass 2, a pressure sheath 3, a pressure armor 4, a tensile armor comprising an innermost tensile armor layer 5 and an outermost tensile armor layer 6, an anti-bird cage layer 1 and a liquid impervious outer sheath 7.

The carcass is liquid pervious and the pressure sheath 3 defines the bore 8. An annulus is formed between the pressure sheath 3 and the outer sheath 7.

The elongate elements of tensile armor layers 5, 6 are cross wound with a long pitch and the elongate element of the pressure armor is wound with a short pitch. The anti-bird cage layer consists of one or more anti-bird cage elongate elements wound with a short pitch, advantageously wound with an angle to the center axis of the pipe of at least about 65°, preferably at least about 75° or even higher. In principle the higher the winding angle, the more will the anti-bird cage layer counteract radial buckling forces of the tensile armor elements.

The pressure armor and the tensile armor is made of corrosion resistant material(s) and the elongate element(s) of the anti-bird cage layer 1 is made of one or more of steel, titanium and/or fibers of carbon, basalt, polyethylene, PVDF (polyvinylidene fluoride or polyvinylidene difluoride) PEEK (polyether ether ketone) PVC (polyvinyl chloride) and LCP (liquid crystalline polymer). The anti-bird cage elongate element(s) is shapes as flat strips e.g. as in FIGS. 4a-4e.

In the installation the unbonded flexible pipe will transport a H₂S and/or CO₂ containing fluid. Since the pressure armor and the tensile armor is made of corrosion resistant material(s), the pH value in the annulus drastically drop for example to pH 4 or even pH 3.5 or less. Due to the selections of the material(s) of the anti-bird cage layer elongate element(s), the anti-bird cage protection may have a long durability and preferably remain stable in the entire service time of the pipe.

The unbonded flexible pipe shown in FIG. 2 comprises a carcass 12 manufactured by winding and folding a metallic tape 12a in such a way that the turns of the tape interlock with each other and thereby limit the displacement between the turns. Around the carcass layer 12, a pressure sheath 13 is arranged. Around the pressure sheath 13, two pressure armor layers 14a, 14b are helically wound with a short pitch. The pressure armor layers 14a, 14b are made of elongate elements in the form of profiled armor wires, where the profile of the wire(s) of the innermost pressure armor layer 14a matches the profile of the wire(s) of the outermost pressure armor layer 14b.

Around the armor layers 14a, 14b, two tensile armor layers 15, 16 are cross wound with a long pitch.

Around the outermost tensile armor layer 16, two or more anti-bird cage layers are applied in the form of elongate elements of cords or bundles of cords of carbon fibers which are wound with a short pitch.

Between the armor layers, optional anti friction layers may be inserted e.g. to lower the friction between the layers, here illustrated in the form of layer 18. Such anti friction layers may advantageously be made of PVDF.

Similarly, a PVDF layer (here comprising wound PVDF tape) 19 may be applied between the outermost tensile armor layer 16 and the anti-bird cage layers 11.

The unbonded flexible pipe further comprises a liquid impervious outer sheath 17.

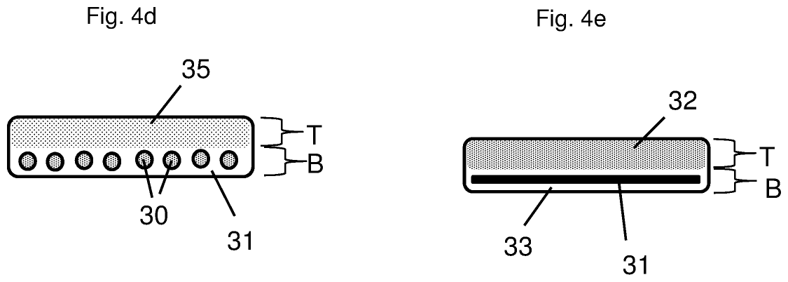

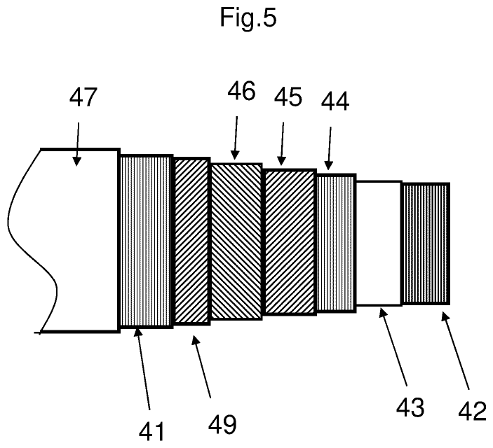

The unbonded flexible pipe shown in FIG. 5 comprises a carcass 42 preferably comprising interlocked wound elements. Around the carcass layer 42, a pressure sheath 43 is located. Around the pressure sheath 43, a pressure armor 44 is located. The pressure armor is advantageously of wound interlocked elements of corrosion resistant material(s), preferably stainless steel.

Around the pressure armor 44, two tensile armor layers 45, 46 are cross wound with a long pitch. The tensile armor layers are advantageously of wound elongate elements of corrosion resistant material(s), preferably stainless steel.

Outside the outermost tensile armor layer 46, a stabilization layer 49 is located. The stabilization layer is provided by helically wound polymeric strips, preferably wound with a winding angle to the center axis of the unbonded flexible pipe, which is low relative to the winding angle of the elongate element(s) of the anti-bird cage layer 41, which is wound onto the stabilization layer 49. The stabilization layer 41 may conveniently have one or more of the functions mentioned above.

Outside the anti-bird cage layer, the outer sheath 47 is located.

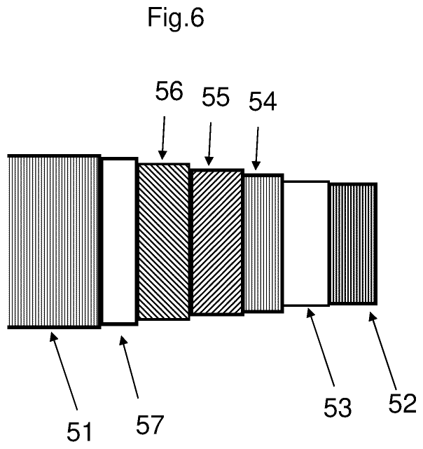

The unbonded flexible pipe shown in FIG. 6 comprises a carcass 52 preferably comprising interlocked wound elements. Around the carcass layer 52, a pressure sheath 53 is located. Around the pressure sheath 53, a pressure armor 54 is located. The pressure armor is advantageously of wound interlocked elements of corrosion resistant material(s), preferably stainless steel.

Around the pressure armor 54, two tensile armor layers 55, 56 are cross wound with a long pitch. The tensile armor layers are advantageously of wound elongate elements of corrosion resistant material(s), preferably stainless steel.

Outside the outermost tensile armor layer 56, the outer sheath is located, preferably in directly physical contact with the outermost tensile armor layer 56. The anti-bird cage layer 51 is located outside the annulus and is applied directly onto the outer sheath 57. A not shown mechanical protection layer may be located outside the anti-bird cage layer.

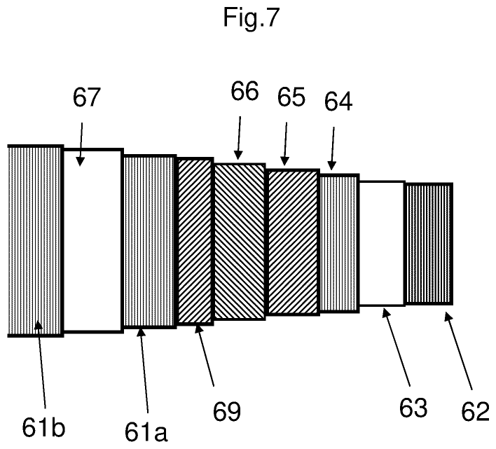

The unbonded flexible pipe shown in FIG. 7 comprises a carcass 62 preferably comprising interlocked wound elements. Around the carcass layer 62, a pressure sheath 63 is located. Around the pressure sheath 63, a pressure armor 64 is located. The pressure armor is advantageously of wound interlocked elements of corrosion resistant material(s), preferably stainless steel.

Around the pressure armor 64, two tensile armor layers 65, 66 are cross wound with a long pitch. The tensile armor layers are advantageously of wound elongate elements of corrosion resistant material(s), preferably stainless steel.

Outside the outermost tensile armor layer 66, a stabilization layer 69 is located. The stabilization layer is conveniently as described above. An anti-bird cage layer 61a, is wound onto the stabilization layer 69.

Outside the anti-bird cage layer, the outer sheath 67 is located. An additional back up anti-bird cage layer 61b is located outside the annulus and is applied directly onto the outer sheath 67. The additional back up anti-bird cage layer 61b serves as a back up layer outside the annulus and may serve as an extra protection in case the anti-bird cage layer in the annulus should be damaged.

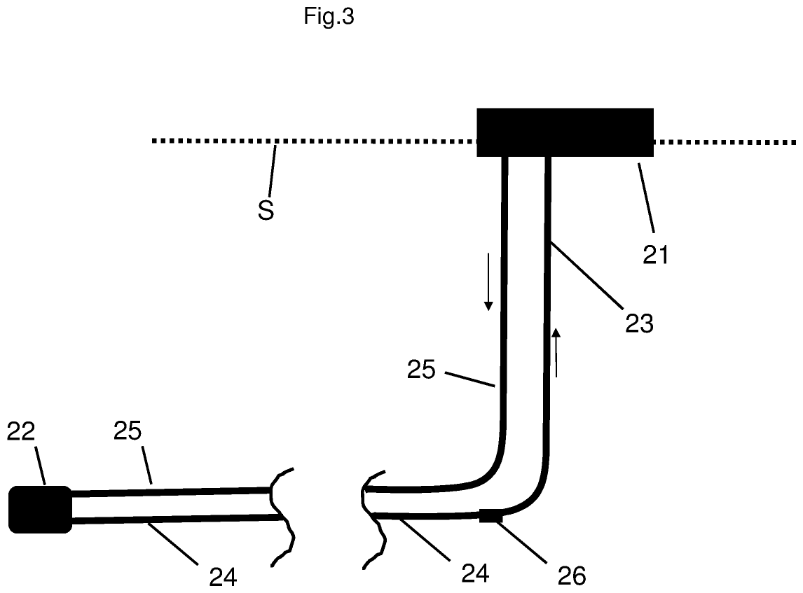

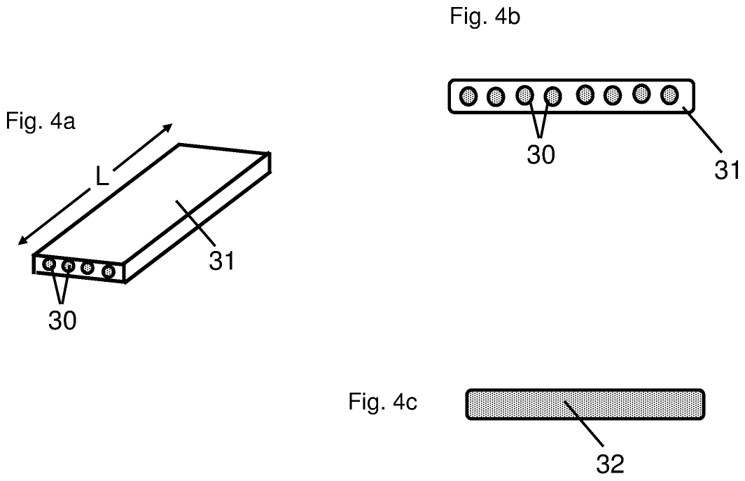

The subsea installation disclosed in FIG. 3 comprises a sea surface installation 21, preferably located at the sea surface S and a seabed installation 22, such as a well and/or a production site.

Two pipelines 23, 24, 25 are arranged to transfer a fluid between the sea surface installation 21 and the seabed installation 22. A first pipeline 23, 24 is arranged to transport a H₂S and/or CO₂ containing fluid from the seabed installation 22 to the sea surface installation 21. The first pipeline 23, 24 comprises a flow line pipe, 24 and a riser pipe 23 interconnected via end-fittings 26. A second pipeline 25 is arranged to transport CO₂ gas from the sea surface installation 21 to the seabed installation 22, e.g. for injection. At least one and preferably two or all three of the second pipeline 25, the flow line pipe 24 and the riser pipe 23 is an unbonded flexible pipe ad described herein and comprising an anti-bird cage layer is made of one or more of steel, titanium and/or fibers of carbon, basalt, polyethylene, PVDF (polyvinylidene fluoride or polyvinylidene difluoride) PEEK (polyether ether ketone) PVC (polyvinyl chloride) and LCP (liquid crystalline polymer).

Examples of elongate elements of the anti-bird cage layer are shown in FIG. 4a-4e.

The elongate element shown in FIG. 4a comprises bundles 30 of twisted or untwisted continuous fibers embedded in an embedding material 31 and are shaped in the form of flat tapes. The bundles of twisted or untwisted continuous fibers are arranged to have their length orientated parallel with the length L of the elongate element. As indicated with the “L” the elongate element may be very long and preferably practically “endless”. This mean that lengths if the elongate element may be coupled to form the practically endless elongate element.

The elongate element shown in FIG. 4b differs from the elongate element of FIG. 4a in that it comprises a larger number of comprises bundles 30 of twisted or untwisted continuous fibers.

The elongate element shown in FIG. 4c comprises cords of continuous fibers 32 embedded in an embedding material. The cords of continuous fibers 32 are arranged to have their length orientated parallel with the length L of the elongate element.

The elongate element shown in FIG. 4d is shaped as a tape and comprises a top portion P and a bottom portion T. The bottom portion B comprises bundles 30 of twisted or untwisted continuous fibers embedded in an embedding material 31. The top portion T comprises cut fibers 35 dispersed in the embedding material. This elongate element is specifically advantageously where the elongate element is part of an anti-bird cage layer which simultaneously form a thermal insulation. The bottom portion B is advantageously closer to the tensile armor layer than the top portion T of the elongate element. Thereby the bottom portion ensures a high anti-bird cage effect, whereas the top portion may insure a good insulation. The cut fibers 35 in the top portion T of the elongate element may have the function of protecting the top portion T against compression due to a high hydrostatic pressure.

The elongate element shown in FIG. 4e is also shaped as a tape and comprises a top portion P and a bottom portion T. The bottom portion B comprises a strip 31 of steel or titanium embedded in an embedding material 33. The top portion T comprises cords of continuous fibers 32 embedded in an embedding material.

This elongate element is also very beneficial where the elongate element is part of an anti-bird cage layer which simultaneously form a thermal insulation. The bottom portion B is advantageously closer to the tensile armor layer than the top portion T of the elongate element. Thereby the bottom portion ensures a high anti-bird cage effect, whereas the top portion may insure a good insulation. The continuous fibers 32 in the top portion T of the elongate element may have the function of protecting the top portion T against compression due to a high hydrostatic pressure

What is claimed is:

1. A subsea installation comprising an unbonded flexile pipe for subsea transportation of a H₂S and/or CO₂ containing fluid, the unbonded flexible pipe comprises from inside and out, a pressure sheath defining a bore for transportation of the fluid, a tensile armor and an outer sheath, wherein the tensile armor is located in an annulus and is of corrosion resistant material(s) and the tensile armor comprises at least two cross wound layers of elongate armor elements, which are wound with a long pith and wherein the pipe further comprises an anti-bird cage layer comprising at least one elongate element wound with a short pitch onto at least one of the tensile armor layers, and wherein said at least one elongate element comprises or consist of steel, titanium and/or fibers of carbon, basalt, polyethylene, PVDF (polyvinylidene fluoride or polyvinylidene difluoride) PEEK (polyether ether ketone) PVC (polyvinyl chloride), LCP (liquid crystalline polymer) or any combinations thereof.

2. The subsea installation of claim 1, wherein the pressure sheath and the outer sheath forms said annulus.

3. The subsea installation of claim 1, wherein the unbonded flexile pipe is arranged for subsea transportation of an acidic crude oil and/or gas, at a raised temperatureof at least 30° C. inside the bore of the pipe.

4. The subsea installation of claim 1, wherein the unbonded flexile pipe is arranged for subsea transportation of a sour fluid comprising at least about 0.5% by weight of sulfur or comprising at least about 100 ppm of H₂S.

5. (canceled)

6. The subsea installation of claim 1, wherein the unbonded flexile pipe is arranged for subsea transportation of fluid containing at least about 100 ppm of CO₂ or containing at least about 10 mol % of CO₂.

7. (canceled)

8. (canceled)

9. The subsea installation of claim 1, wherein the pH value in at least a location of the annulus is about 4.5 or less.

10. (canceled)

11. The subsea installation of claim 1, wherein the fluid is a CO₂ containing injection fluid and the unbonded flexile pipe is arranged for transporting the injection fluid at least a part of a way from a sea surface installation to a seabed installation.

12. The subsea installation of claim 1, wherein at least a length section of the unbonded flexible pipe is located at least about 100 m below sea surface.

13. The subsea installation of claim 1, wherein the elongate element of the anti-bird cage layer is wound with an angle of at least about 65° to the center axis of the unbonded flexible pipe and wherein the elongate element of the anti-bird cage layer comprises fibers of stainless steel, titanium, carbon, basalt, ultra-high-molecular polyethylene (UHMWPE) LCP (liquid crystalline polymer), or any combinations thereof.

14. (canceled)

15. (canceled)

16. (canceled)

17. (canceled)

18. The subsea installation of claim 1, wherein the fibers are embedded in a polymer material, wherein the polymer material is polyethylene, PVDF, PEEK, PVC or any combination thereof, and wherein the fibers are dispersed in the embedding material which is in the form of flat tapes, with a thickness of from 0.2 mm to 3 mm.

19. (canceled)

20. (canceled)

21. (canceled)

22. (canceled)

23. (canceled)

24. The subsea installation of claim 18, wherein the anti-bird cage layer comprises a steel strip or a titanium strip.

25. The subsea installation of claim 1, wherein the unbonded flexible pipe comprises two or more anti-bird cage layers.

26. (canceled)

27. (canceled)

28. The subsea installation of claim 1, wherein the anti-bird cage layer is located in the annulus in physical contact with at least one of the tensile armor layers.

29. The subsea installation of claim 1, wherein the unbonded flexible pipe further comprises a stabilization layer located outside the tensile armor layers and wherein the anti-bird cage layer is located onto and in contact with said stabilization layer, and wherein the stabilization layer is made from helically wound polymeric strips.

30. (canceled)

31. The subsea installation of claim 29, wherein the helically wound polymeric strips are wound with a longer pitch than the pitch of the at least one elongate element of the anti-bird cage layer, the helically wound polymeric strips are wound with an angle to the center axis of the unbonded flexible pipe, which is at least about 10° less than the winding angle of the elongate element(s) of the anti-bird cage layer.

32. (canceled)

33. (canceled)

34. (canceled)

35. (canceled)

36. The subsea installation of claim 1, wherein the corrosion resistant material(s) comprises stainless steel, titanium, composite material or any combinations thereof and wherein the composite material comprises a fiber reinforced polymer material.

37. (canceled)

38. (canceled)

39. (canceled)

40. The subsea installation of claim 1, wherein the unbonded flexible pipe comprises a pressure armor located between the pressure sheath and the tensile armor, the pressure armor is of one or more of the corrosion resistant material(s).

41. (canceled)

42. (canceled)

43. (canceled)

44. (canceled)

45. An unbonded flexile pipe for subsea transportation of a H₂S and/or CO₂ containing fluid, the unbonded flexible pipe comprises from inside and out, a pressure sheath defining a bore for transportation of the fluid, a tensile armor and a liquid impervious outer sheath, wherein the tensile armor is of corrosion resistant material(s) and the tensile armor comprises at least two cross wound layers of elongate armor elements, which are wound with a long pith and wherein the pipe further comprises an anti-bird cage layer comprising at least one elongate element wound with a short pitch onto at least one of the tensile armor layers, and wherein said at least one elongate element comprises or consist of steel, titanium and/or fibers of carbon, basalt, polyethylene, PVDF (polyvinylidene fluoride or polyvinylidene difluoride) PEEK (polyether ether ketone) PVC (polyvinyl chloride), LCP (liquid crystalline polymer) or any combinations thereof.
